(19) United States
(12) Patent Application Publication
(10) Pub. No.: US 2024/0217493 A1
(43) Pub. Date: Jul. 4, 2024

(54) REMOTE BRAKE FLUID RESERVOIR SYSTEM

(71) Applicant: Rivian IP Holdings, LLC, Plymouth, MI (US)

(72) Inventors: Ajay Kumar PULLURI, Hinckley (GB); William S. JANG, Fullerton, CA (US); Shanker KRISHNAN, Irvine, CA (US); Michelle Renee PFARRER, Oakland, MI (US); Allen Martin ORCHARD, Shepperton (GB)

(21) Appl. No.: 18/091,250

(22) Filed: Dec. 29, 2022

(51) Int. Cl. B60T 13/14; B60T 17/04; B60T 17/06; B62D 65/02

(52) U.S. Cl. CPC B60T 13/142; B60T 17/04; B60T 17/06; B62D 65/02

(57) ABSTRACT

A remote brake fluid reservoir, a remote brake fluid reservoir connected to a brake cylinder, vehicle assemblies with the same, parts facilitating the vehicle assemblies, and methods of manufacturing, integrating, and using the same are described herein. The remote brake fluid reservoir and the brake cylinder may be separated by a bulkhead on a body of a vehicle. Additionally, a brake fluid path can extend from the brake fluid reservoir to the brake cylinder through an opening in the bulkhead, the opening in the bulkhead having a seal. The remote brake fluid reservoir may be mounted within a front compartment of the vehicle. A center line of the brake fluid reservoir can be aligned with a center line of the vehicle. In addition, the brake cylinder may be located in a different compartment of the vehicle, such as a cabin of the vehicle, for example.

### INTRODUCTION

Brake fluid reservoirs can be used to store brake fluid and to supply brake fluid to a master cylinder mounted on the brake reservoir. Brake reservoirs can also receive excess oil through a compensating port. The master cylinder feeds the brake fluid, supplied by the brake fluid reservoir, into a brake circuit to convert pressure on the brake to hydraulic pressure. Upon releasing the brake, the brake reservoir can receive brake fluid from a brake line of the brake circuit. Vehicles, however, presently lack the space and/or features needed to support adaptable and efficient brake fluid reservoir and master cylinder systems, among other limitations.

### SUMMARY

This summary is provided to introduce a selection of concepts in a simplified form that are further described below in the detailed description section of this disclosure. This summary is not intended to identify key features or essential features of the claimed subject matter, nor is it intended to be used as an aid in determining the scope of the claimed subject matter.

In brief, and at a high-level, this disclosure describes, among other things, a remote brake fluid reservoir, a remote brake fluid reservoir connected to a brake cylinder, vehicle assemblies with the same, parts facilitating the vehicle assemblies, and methods of manufacturing, integrating, and using the same.

The brake fluid reservoirs described herein may include one or more brake fluid chambers and a cap (e.g., a hermetic seal) that closes a brake fluid chamber from the surrounding environment. The brake fluid reservoir may be coupled to a brake cylinder for transfer of brake fluid to the brake cylinder. For example, some embodiments may include a brake fluid path that is coupled to the brake fluid reservoir at a bottom portion of the brake reservoir. Continuing the example, the brake fluid path may include a corrugated hose clamped to a connection nipple (e.g., a connection nipple having a bored cylinder, the connection nipple molded into the brake reservoir) located on the bottom portion of the brake reservoir. In addition, the brake cylinder may have one or more pistons (e.g., one piston connected to a rod and a free piston), and the brake cylinder can generate a brake fluid pressure that may be associated with a braking operation of the vehicle.

In some embodiments, the brake fluid reservoir is positioned adjacent to one side of a bulkhead on a body of a vehicle, and the brake cylinder is positioned adjacent to another side of the bulkhead. For example, the brake fluid reservoir may be located in a front compartment of the vehicle, and the brake cylinder may be located in a cabin of the vehicle. In other embodiments, the bulkhead separates a first compartment and a second compartment of a vehicle, and the brake cylinder is located in the first compartment and the brake fluid reservoir located in the second compartment. For example, the first compartment may be a cabin of the vehicle, and the second compartment may be a front compartment of the vehicle.

In addition, a center line of the brake fluid reservoir may be aligned with a center line of the vehicle, in some embodiments. Additionally, a brake fluid path from the brake fluid reservoir to the brake cylinder may extend through an opening in the bulkhead. In some embodiments, a seal (e.g., a plastic seal) may cover at least a portion of the opening in the bulkhead. The seal may comprise at least two pieces (e.g., a top piece and a bottom piece) that together form a portion of the seal that surrounds the brake fluid path (e.g., the corrugated hose), such that the brake fluid path can extend from the first compartment to the second compartment of the vehicle. In some embodiments, a plurality of pathways extend through the opening in the bulkhead, and each of the pathways may be surrounded by a portion of the seal.

The embodiments described herein can provide a utility-driven, space-efficient, and multi-functional operational environment for a vehicle. For example, the remote brake fluid reservoir described herein can provide for improved packaging or reduced difficulties in packaging (e.g., difficulties based on cantilevered weight from the brake fluid reservoir being mounted on the cylinder). This in turn allows vehicles to have a variety of differing hood designs, such as smaller or compact hood designs, for example, among other benefits.

### BRIEF DESCRIPTION OF THE DRAWINGS

The remote brake fluid reservoir, remote brake fluid reservoir connected to the brake cylinder, vehicle assemblies with the same, parts facilitating the vehicle assemblies, and methods of manufacturing, integrating, and using the same described herein are discussed in detail below with reference to the attached drawing figures, wherein:

FIG. 1 depicts a perspective view of a vehicle with a brake fluid reservoir and a brake cylinder, in accordance with an embodiment of the present disclosure;

FIG. 2 depicts a remotely mounted brake fluid reservoir, in accordance with an embodiment of the present disclosure;

FIG. 3 depicts a remote brake fluid reservoir and a brake cylinder separated by a bulkhead, in accordance with an embodiment of the present disclosure;

FIG. 4 depicts a remote brake fluid reservoir and a brake fluid path connected to the brake fluid reservoir and extending through an opening in the bulkhead and to a brake cylinder, in accordance with an embodiment of the present disclosure;

FIG. 5 depicts another perspective view of the remote brake fluid reservoir and brake fluid path extending through the opening in the bulkhead and to a brake cylinder, in accordance with an embodiment of the present disclosure;

FIG. 6 depicts the remote brake fluid reservoir and opening in the bulkhead of FIG. 4, the opening having a seal, in accordance with an embodiment of the present disclosure;

FIG. 7 depicts another perspective view of the remote brake fluid reservoir and brake fluid path extending through the seal of the opening in the bulkhead, in accordance with an embodiment of the present disclosure; and

FIG. 8 depicts a block diagram of an example method of manufacturing and integrating the remote brake fluid reservoir into the vehicle, in accordance with an embodiment of the present disclosure.

### DETAILED DESCRIPTION

This detailed description is provided in order to meet statutory requirements. However, this description is not intended to limit the scope of the invention described herein. Rather, the claimed subject matter may be embodied in different ways, e.g., to include different steps, different combinations of steps, different elements, and/or different combinations of elements, similar to those described in this disclosure, and in conjunction with other present or future technologies and/or techniques. The terms “step” and “block” may be used herein to identify different elements of methods employed, but these terms should not be interpreted as implying any particular order among or between different elements except when such order is explicitly stated.

The technology disclosed herein relates to a remote brake fluid reservoir system that can eliminate the cantilevered weight introduced by traditional systems and can reduce difficulty in packaging. Further, the remote brake fluid reservoir system allows for a variety of differing hood designs, such as a smaller and more compact hood, for example. Additionally, if the vehicle is involved in an accident, the possibility of damages resulting from on a crowded hood space may be reduced. Moreover, the possibility of sharp objects from the remote brake fluid reservoir system protruding into the cabin of the vehicle may be reduced.

In general, disclosed herein include, among other things, a remote brake fluid reservoir, a remote brake fluid reservoir connected to a brake cylinder via a brake fluid path, vehicle assemblies with the same, parts facilitating the vehicle assemblies, and methods of manufacturing, integrating, and using the same. For example, one embodiment of a system may comprise a bulkhead on a body of a vehicle, the bulkhead having a first side and a second side. The brake cylinder may be adjacent to the first side of the bulkhead, and the brake fluid reservoir may be adjacent to the second side of the bulkhead. The brake fluid reservoir can be coupled to the brake cylinder by the brake fluid path for the transfer of brake fluid to the brake cylinder.

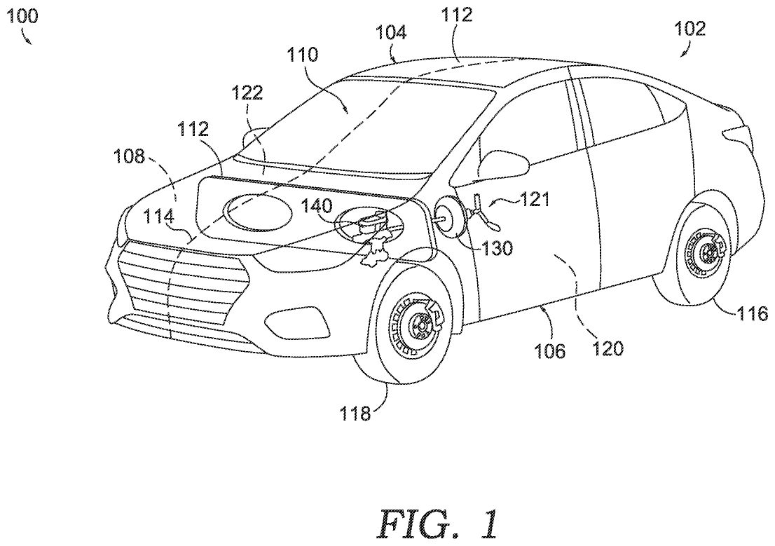

In another embodiment, the bulkhead may separate a first compartment and a second compartment, and the brake cylinder may be located in the first compartment. Continuing the example, the brake fluid reservoir may be located in the second compartment, and the brake fluid reservoir may be connected to the brake cylinder. In some aspects, a center line of the brake fluid reservoir may be affixed at a center line of the vehicle. The remote brake reservoir described herein can include any one or combination of the example embodiments described in detail below in connection with FIGS. 1-8.

The brake fluid reservoirs and brake cylinders described herein are discussed as being integrated into different vehicles. The vehicles discussed herein may include passenger vehicles such as cars, trucks, pickup trucks, SUVs, or may include commercial or industrial vehicles, among others. In addition, the embodiments described herein may be implemented in vehicles that are combustion-powered and/or electric-powered, e.g., such as hybrid electric vehicles, battery electric vehicles, plug-in hybrid electric vehicles, or other types of vehicles. The embodiments described herein may also be used with manually, autonomously, and/or semi-autonomously operated vehicles, among others.

Other exemplary aspects are also disclosed. Like reference symbols in the various drawings indicate like elements.

FIG. 1 includes a perspective view of an example vehicle 100. Vehicle 100 has a body 102 having a top portion 104 that is joined to a bottom portion 106. The vehicle 100 also has a front compartment 108 and a cabin 110. The top portion 104 of the vehicle 100 has one or more vehicle body panels 112. The bottom portion comprises a vehicle chassis 120, a drivetrain 121, and a bulkhead 122. The bulkhead 122 is positioned between the front compartment 108 and the cabin 110. A center line 114 of the vehicle 100 follows a center line of the vehicle chassis 120. The centerline 114 of the vehicle 100 is between the rear wheels 116 of the vehicle 100 and between the front wheels 118 of the vehicle 100.

The bulkhead 122 has a first side and a second side, wherein the first side of the bulkhead 122 is adjacent to a brake cylinder 130 and the second side of the bulkhead 122 is adjacent to a brake fluid reservoir 140. The brake fluid reservoir 140 is located in the front compartment 108 and the brake cylinder 130 is located in the cabin 110. As such, this design allows for an enhanced modular vehicle assembly, as the configuration and packaging of the brake fluid reservoir 140 and brake cylinder 130 can be used for a plurality of various reservoir brake fluid reservoir 140 and brake cylinder 130 sizes and configurations to be joined to the bottom portion 106 of the vehicle 100. For example, this configuration allows for various numbers and sizes of brake fluid chambers of the brake fluid reservoir 140. As another example, this configuration allows for various types of positioning of the brake fluid reservoir 140 other than installation directly above the brake cylinder 130.

Further, by incorporating this brake system corresponding to the brake cylinder 130 and brake fluid reservoir 140 into the bulkhead 122, the brake system can be assembled for the vehicle 100 before the top portion 104 is joined to the bottom portion 106. As such, this design allows for an enhanced modular vehicle assembly, as the configuration and packaging of the reservoir brake fluid reservoir 140 can be used for a plurality of various top portion 104 configurations to be joined to the bottom portion 106.

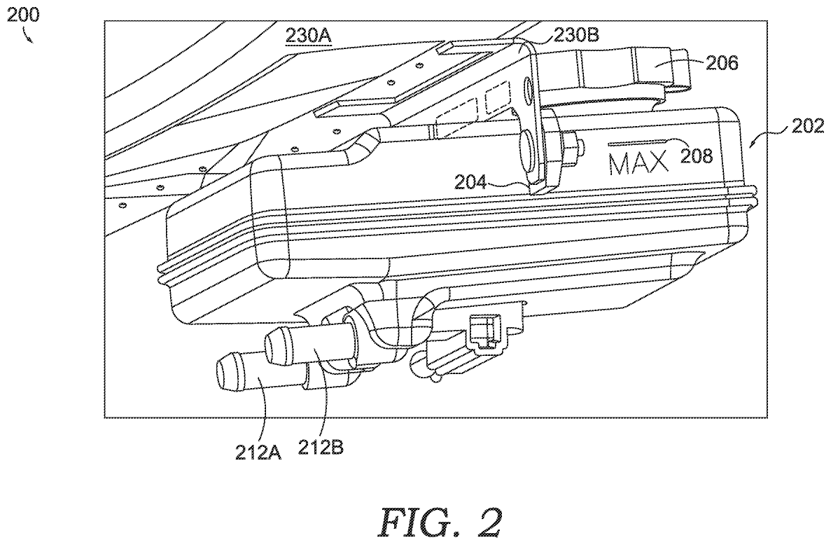

FIG. 2 depicts an example environment 200 for a remotely mounted brake fluid reservoir. The brake fluid reservoir 202 can be formed by welding a top part and a bottom part together at wall edges. In some embodiments, the brake fluid reservoir 202 can be made of one or more of a polymer plastic (e.g., a transparent polymer), a metal, or a combination thereof. For example, an internal surface of the brake fluid reservoir 202 that is in contact with the brake fluid may comprise a polymer plastic, whereas the external surface of the brake fluid reservoir 202 may comprise a metal or metal alloy, for example. The brake fluid reservoir 202 may have one or more brake fluid chambers for housing the brake fluid, as well as one or more internal level sensors.

In embodiments, the remotely mounted brake fluid reservoir 202 may include one or more mounting structures 204 for mounting the brake fluid reservoir 202. In some embodiments, the one or more mounting structures 204 can be formed during the casting of the top or bottom part, and in other embodiments, the one or more mounting structures are coupled to an exterior portion of the brake fluid reservoir 202 after welding the top part and bottom part of the brake fluid reservoir 202 together at the wall edges. For example, in embodiments wherein the brake fluid reservoir 202 is located in a front compartment of the vehicle (e.g., vehicle 100 of FIG. 1), the one or more mounting structures 204 can be coupled to a mounting wall of the front compartment of the vehicle via a fastener, such as a screw (e.g., a machine screw, a sheet metal screw, a wood screw, a cap screw, or another type of screw), a bolt, a stud, a washer, an anchor, a rivet, a nail, another type of fastener, or a combination thereof.

As depicted in example environment 200, the brake fluid reservoir 202 may include one or more caps 206 (e.g., a hermetic seal) for closing a fill opening of the brake fluid reservoir 202. For example, the brake fluid reservoir may receive brake fluid via an evacuate-and-fill method or bleed mechanism, for example. In some embodiments, the brake fluid reservoir 202 stores the brake fluid at atmospheric pressure. In some embodiments, the cap 206 is located at a top portion of the brake fluid reservoir 202. In some embodiments, the cap 206 is hermetically sealed. In some embodiments, the brake fluid reservoir 202 may have a brake fluid maximum indicator 208. In other embodiments, the brake fluid reservoir 202 may have a brake fluid minimum indicator, a maximum indicator and a minimum indicator, another type of indicator, or a combination thereof.

The vehicle (e.g., vehicle 100 of FIG. 1) can comprise brake fluid reservoir 202 can have a brake rod extending in a rearward direction of the vehicle, the rearward direction being opposite of a forward direction of the vehicle. In some embodiments, the brake fluid reservoir 202 can be coupled to the mounting wall (e.g., in the front compartment of the vehicle) in a direction that is forward from the brake pedal and aligned with a center line of the vehicle. For example, the center line of the brake fluid reservoir 202 can be aligned with a center line of the vehicle between a front left wheel of the vehicle and a front right wheel of the vehicle. Embodiments wherein the brake fluid reservoir 202 is aligned with the center line of the vehicle can be implemented for vehicles having a right-hand drive or a left-hand drive configuration. For example, aligning the brake fluid reservoir 202 with the center line of the vehicle can provide for proper alignment of the right-hand drive or a left-hand drive steering system (e.g., an alignment associated with the spokes of a steering wheel in a neutral position that can be detected using torque sensors). The center line of the brake fluid reservoir 202 can be parallel to vertical edges of the brake fluid reservoir 202.

Further, in some embodiments, the brake fluid reservoir 202 is in a direction forward of the brake cylinder. At least the top portion of the brake fluid reservoir 202 can be positioned at a height above the brake cylinder. In some embodiments, one portion of the top portion of the brake fluid reservoir 202 is positioned at a height above another portion of the top portion of the brake fluid reservoir 202, such that brake fluid outlets 212A and 212B are positioned at a downward angle.

Brake fluid outlets 212A and 212B of the brake fluid reservoir 202 correspond to brake fluid inlets of the brake cylinder. In example environment 200, the brake fluid outlets 212A and 212B of the brake fluid reservoir 202 face the rearward direction of the vehicle. In some embodiments, the brake fluid outlets 212A and 212B comprise a pair of bored cylinders molded into and extending from the bottom portion of the brake fluid reservoir 202. Additionally or alternatively, the brake fluid outlets 212A and 212B can face towards a bulkhead of the vehicle, the bulkhead separating a compartment of the vehicle corresponding to the brake fluid reservoir 202 and another compartment of the vehicle corresponding to a brake cylinder. Continuing the example, the compartment corresponding to the brake fluid reservoir 202 can be in a forward direction of the vehicle from the compartment corresponding to the brake cylinder. Further, the compartment corresponding to the brake fluid reservoir 202 can be the front compartment of the vehicle.

In embodiments wherein the brake fluid outlets 212A and 212B comprise the pair of bored cylinders, the pair of bored cylinders can be in communication with a pressure chamber of the brake cylinder via a quick connect end at each of the pair of bored cylinders and a corrugated hose clamped at the quick connect end. The brake fluid reservoir 202 and brake fluid outlets 212A and 212B are configured to the brake cylinder for the flow of brake fluid from the brake fluid reservoir 202 to the brake cylinder and to a brake pump (e.g., a brake pump having an electric actuator). The brake fluid outlets 212A and 212B can extend from the bottom portion of the brake fluid reservoir 202 for transferring brake fluid to one or more brake fluid chambers. In other embodiments, the brake fluid reservoir 202 has more than two brake fluid outlets. In some embodiments, one or more of the brake fluid outlets connect to a primary brake fluid chamber of the brake cylinder, one or more of the brake fluid outlets connect to a secondary brake fluid chamber of the brake cylinder, one or more of the brake fluid outlets connect to another brake fluid chamber corresponding to the electric actuator, or a combination thereof.

Furthermore, in example environment 200, the brake fluid reservoir 202 is coupled to mounting wall 230A via mounting wall adapter 230B by the one or more mounting structures 204 formed within the brake fluid reservoir 202 or welded onto the brake fluid reservoir 202, for example. In an embodiment, mounting wall 230A is sheet metal or another mounting wall material capable of supporting weight of the brake fluid reservoir 202 and the brake fluid contained within the brake fluid reservoir 202. In some embodiments, mounting wall 230A is a portion of the bulkhead separating at least two compartments of the vehicle. Further, the mounting wall adapter 230B may comprise sheet metal, another metal, or another mounting wall adapter material capable of supporting the reservoir 202 while mounted to the mounting wall 230A (e.g., via mounting fasteners such as nuts and bolts, for instance). In some embodiments, a center line of the brake fluid reservoir 202 is aligned with a center line of the vehicle, which is facilitated by the configuration of the mounting wall 230A, the mounting wall adapter 230B, and the one or more mounting structures 204.

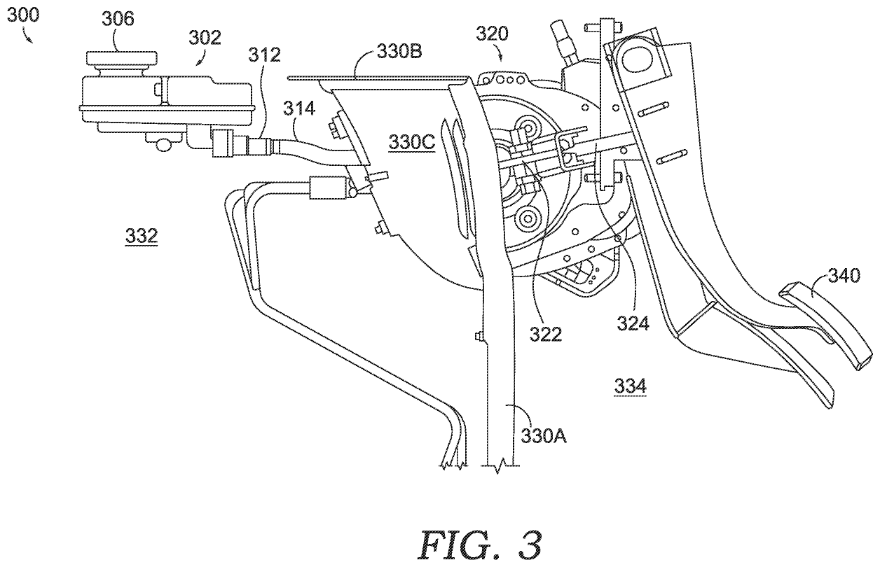

FIG. 3 illustrates another view of an example brake fluid reservoir in example environment 300. In embodiments, brake fluid reservoir 302 may be separated from brake cylinder 320 by a bulkhead 330A. Brake fluid reservoir 302 may have a cap 306 (such as cap 206 in FIG. 2, for example) that encloses the brake fluid within the brake fluid reservoir 302 from the atmosphere, such as by securing the cap 306 onto the brake fluid reservoir 302 via a screwed joint, for example. The brake fluid in the brake fluid reservoir 302 is in communication with the brake cylinder 320 via the reservoir brake fluid outlet 312 (e.g., the brake fluid outlets 212A and 212B of FIG. 2), brake fluid path 314, and one or more brake fluid inlets of the brake cylinder. The reservoir brake fluid outlet 312 is in communication with the brake fluid inlet of the brake cylinder via the brake fluid path 314. The brake fluid path 314 extends through an opening in an upper portion of the bulkhead 330C and to the brake cylinder 320, the opening being below the top plane of the bulkhead 330B.

In some embodiments, the brake fluid path 314 is a hose, a corrugated hose, or another type of brake fluid path. The material of brake fluid path 314 may include, for example, rubber, such as silicone rubber for example, and the inner surface of the brake fluid path 314 is a material that is compatible with brake fluid. For example, the material of at least the inner surface of the brake fluid path 314 can include an elastomeric material (e.g., an inert gum rubber resistant to organic solvent). In some embodiments, the brake fluid path 314 extends from the brake fluid reservoir 302, located in a compartment 332 (e.g., a front compartment) and separated from the brake cylinder 320 by the bulkhead 330A. As such, the brake fluid path 314 extends from compartment 332 to compartment 334 (e.g., a cabin), which contains the brake cylinder 320.

The compartment in which the brake fluid reservoir 302 is located is in a direction forward of the brake cylinder 320, the forward direction being opposite of a rearward direction of the vehicle (e.g., vehicle 100 of FIG. 1). In some embodiments, the brake fluid reservoir 302 is forward from the brake cylinder 320 and brake pedal 340. The brake cylinder 320 is also in a direction of the vehicle that is forward from the brake pedal 340. The brake cylinder 320 can be located in a cabin of the vehicle and the brake fluid reservoir 302 can be located in a front compartment of the vehicle. In some embodiments, a center line of the brake fluid reservoir 302 is aligned with a center line of the vehicle. For example, the center line of the brake fluid reservoir 302 can be aligned with a center line of the bulkhead 330A between a front left wheel of the vehicle and a front right wheel of the vehicle.

The brake cylinder 320 is mechanically connected to the brake pedal 340. In some embodiments, the brake cylinder 320 includes or is in communication with a pressure generator (e.g., a motor operated piston cylinder). The pressure generator may also be in communication with the brake fluid reservoir 302. The brake cylinder 320 is hydraulically connected to the brake fluid reservoir 302 via the brake fluid path 314, which may include a pressure sensor in some embodiments. In one embodiment, one or more chambers of the brake cylinder 320 are hydraulically connected to the brake fluid reservoir 302 by one or more brake fluid paths. As depicted in example environment 300, the brake cylinder 320 may have a chamber and a piston 322, as well as another chamber and another piston 324. For example, the pistons 322 and 324 can be mechanically attached. As another example, one or more of pistons 322 and 324 can be coupled to a hydraulically active surface area. Piston 324 can be directly coupled to the brake pedal 340.

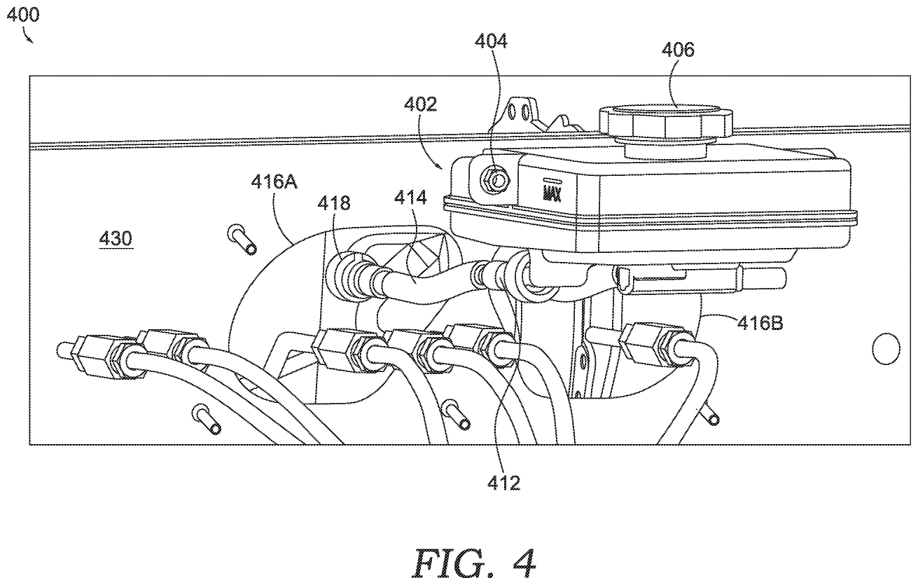

FIG. 4 illustrates another view of an example brake fluid reservoir in example environment 400. Brake fluid reservoir 402 is located in a compartment of a vehicle (e.g., vehicle 100 of FIG. 1) that is separated from another compartment, where the brake cylinder is located, at least by bulkhead surface 430. In example environment 400, brake fluid reservoir 402 has mounting structure 404 (such as mounting structure 204 in FIG. 2, for example) for mounting the brake fluid reservoir 402 in the corresponding vehicle compartment and a cap 406 (such as cap 206 in FIG. 2, for example). In an embodiment, the cap 406 is located at a center of the top surface of the reservoir 406, and the cap 406 is aligned with a center line of the vehicle. For example, a center line of the vehicle may be determined using the four wheels of the vehicle.

The brake fluid reservoir 402 is in communication with the brake cylinder located in the other compartment via the reservoir brake fluid outlet 412 (e.g., the brake fluid outlets 212A and 212B of FIG. 2), brake fluid path 414 (e.g., the brake fluid path 314 of FIG. 3), and one or more brake fluid inlets 418 of the brake cylinder. The brake fluid path 414 extends from the brake fluid reservoir 402, located in the one compartment of the vehicle, to the brake cylinder, located in the other compartment, through an opening 416A in the bulkhead 430. The brake cylinder can be in communication with other lines via the openings 416A and 416B or another opening in the bulkhead 430. The openings in the bulkhead (e.g., openings 416A and 416B) can be drilled or carved out after manufacture of the bulkhead 430. In other embodiments, the openings 416A and 416B can be formed during the casting of the bulkhead 430. The openings 416A and 416B can be of various shapes and sizes.

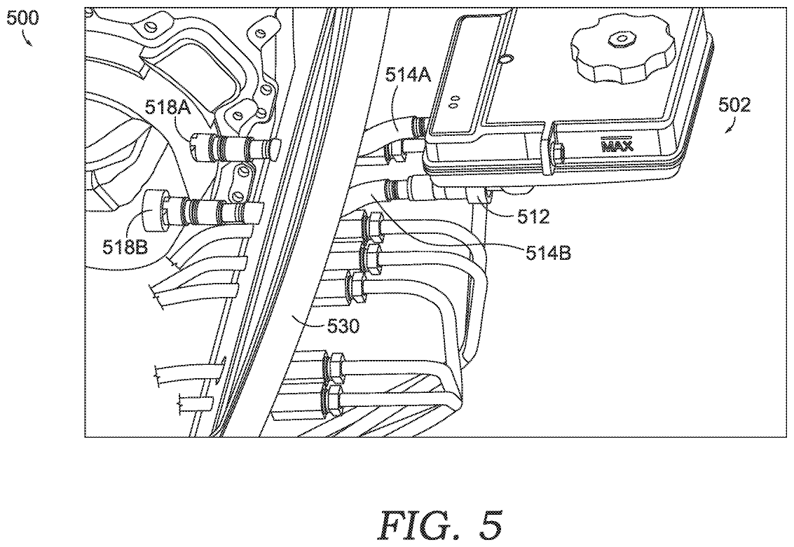

FIG. 5 illustrates another view of an example brake fluid reservoir in example environment 500. Remote brake fluid reservoir 502 is located in a compartment of a vehicle (e.g., vehicle 100 of FIG. 1) that is separated from another compartment which houses the brake cylinder. For example, the brake fluid reservoir 502 can be located in a front compartment of the vehicle and the brake cylinder can be located in a cabin of the vehicle, wherein the cabin compartment is in a more rearward direction of the vehicle than the front compartment. Further, the brake cylinder can be coupled to a brake pedal or another type of braking input device. In some embodiments, the brake cylinder includes a brake pressure booster.

In example environment 500, brake fluid reservoir 502 has brake fluid outlet 512 (such as brake fluid outlets 212A and 212B of FIG. 2, for example). For example, the brake fluid outlet 512 and another brake fluid outlet of the brake fluid reservoir 502 are in communication with brake fluid inlets 518A and 518B of the brake cylinder via the brake fluid paths 514A and 514B (such as brake fluid path 314 of FIG. 3, for example). The brake fluid paths 514A and 514B can extend from the brake fluid reservoir 502 to the brake cylinder through one or two openings (e.g., openings 416A and 416B of FIG. 4) in the bulkhead 530. In some embodiments, the length of brake fluid path 514A is shorter or longer than the length of brake fluid path 514B; and in other embodiments, the lengths of the brake fluid paths 514A and 514B are equivalent. In some embodiments, an external portion of each of the brake fluid paths 514A and 514B is composed of a different type of rubber. In some embodiments, the vehicle corresponding to environment 500 includes a brake pedal or another type of braking input device (e.g., a lever mechanically coupled to the brake cylinder) on the left side of the car. In other embodiments, the vehicle corresponding to environment 500 includes a braking input device on the right side of the car. In yet another embodiment, the braking input device, which is in communication with the brake cylinder, is in a central location of the car.

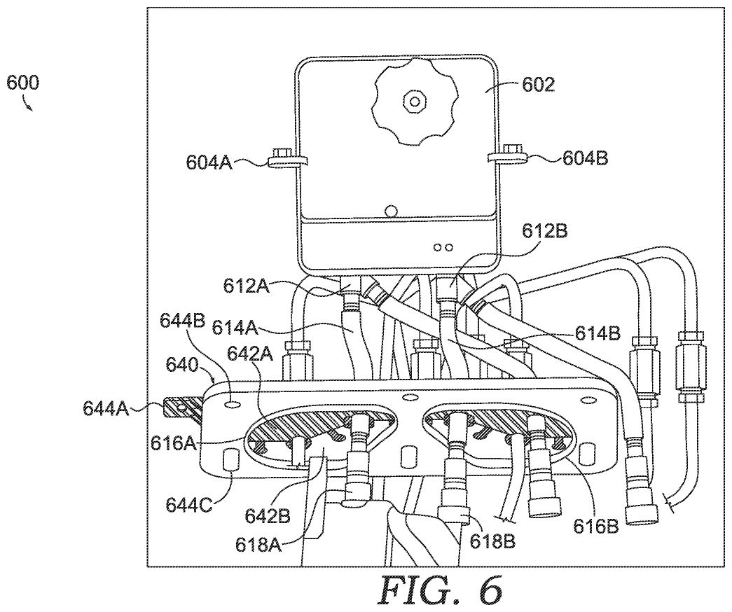

FIG. 6 depicts yet another view of an example brake fluid reservoir in example environment 600. Example environment 600 illustrates a brake fluid reservoir 602 that is in communication with the brake cylinder via brake fluid paths 614A and 614B, which each extend through one of openings 616A and 616B (e.g., openings 416A and 416B of FIG. 4) of the bulkhead. For example, the brake fluid reservoir 602 can be located in a front compartment of the vehicle and attached to one or more mounting walls within the front compartment via mounting structures 604A and 604B (e.g., mounting structure 204 of FIG. 2). The mounting structures 604A and 604B can be formed during a casting or molding of the brake fluid reservoir 602, in some embodiments. In other embodiments, the brake fluid reservoir 602 can include more than two mounting structures. As an example, the mounting structures 604A and 604B can be made of a plastic or metal, and the mounting structures 604A and 604B can be fastened to one or more mounting walls within the front compartment of the vehicle via one or more fasteners, which may include one or more plastic or metal fasteners.

The brake fluid reservoir 602 can include brake fluid outlets 612A and 612B that are connected to the brake fluid paths 614A and 614B extending through one or more of the openings 616A and 616B in the bulkhead of the vehicle that separates the compartment in which the brake fluid reservoir 602 is located from the compartment in which the brake cylinder is located. The brake fluid paths 614A and 614B extend through the openings 616A and 616B in the bulkhead and are connected to the brake fluid inlets 618A and 618B of the brake cylinder. In example environment 600, the brake fluid paths 614A and 614B also extend through plastic seal 640 covering the openings 616A and 616B in the bulkhead.

The openings 616A and 616B are between at least two sides of the bulkhead, wherein the first side of the bulkhead faces inward toward a compartment that the brake cylinder is located in and the second side of the bulkhead faces inward toward a different compartment that the brake fluid reservoir 602 is located in. As such, the plastic seal 640 can cover the openings 616A and 616B. For example, the plastic seal 640 can be coupled to a portion of one of the at least two sides of the bulkhead. In aspects, the plastic seal 640 can be attached to the side of the bulkhead facing inward toward the compartment that the brake fluid reservoir 602 is located in. As illustrated in example environment 600, the plastic seal 640 is attached to the bulkhead via mounting structures 644A, 644B, and 644C. In other embodiments, the plastic seal 640 is attached to the bulkhead via one or more of mounting structure 644A, one or more of mounting structure 644B, one or more of mounting structure 644C, one or more of mounting structures 644A and 644B, one or more of mounting structures 644A and 644C, one or more of mounting structures 644B and 644C, one or more of another type of mounting structure, or a combination thereof.

In some embodiments, the plastic seal 640 is made of one or more polymeric materials. For example, the plastic seal 640 can be made of a natural polymer, a synthetic polymer, another type of polymer, or a combination thereof. In some embodiments, the plastic seal 640 includes a blow molded polyethylene. Further, the plastic seal 640 can be attached to the bulkhead via one or more fasteners and the mounting structures 644A, 644B, and 644C. The one or more fasteners, for example, can include a screw (e.g., a machine screw, a sheet metal screw, a wood screw, a cap screw, or another type of screw), a pin, a stud, a washer, an anchor, a rivet, a nail, another type of fastener, or a combination thereof. In some embodiments, a surface of the mounting structures 644A, 644B, and 644C associated with the fastener may comprise a film of a composition of matter different than that of the plastic seal 640.

In other embodiments, the plastic seal 640 can be attached to the bulkhead via one or more frangible connections. For example, in some embodiments, at least a portion of a frangible connection is integrated into the plastic seal 640 during manufacture of the plastic seal 640, for example. Further, the plastic seal 640 can have at least one opening for each of the brake fluid paths 614A and 614B to extend through from a first compartment associated with the brake fluid reservoir 602 to a second compartment associated with the brake cylinder. As such, brake fluid path 614A, for example, can extend from the brake fluid reservoir 602 to the brake cylinder through the plastic seal 640 and through the opening 616A in the bulkhead.

As illustrated in example environment 600, the plastic seal 640 comprises a top piece 642A and a bottom piece 642B, the top piece 642A and the bottom piece 642B sealing the opening 616A in the bulkhead. In addition, the top piece 642A and the bottom piece 642B can also form together to seal the opening 616B in the bulkhead. As such, the top piece 642A of the plastic seal 640 can extend across both of the openings 616A and 616B. In addition, the bottom piece 642B of the plastic seal 640 can extend across both of the openings 616A and 616B. In some embodiments, the top piece 642A and the bottom piece 642B can form an opening in the plastic seal 640 for each of the brake fluid paths 614A and 614B to extend through.

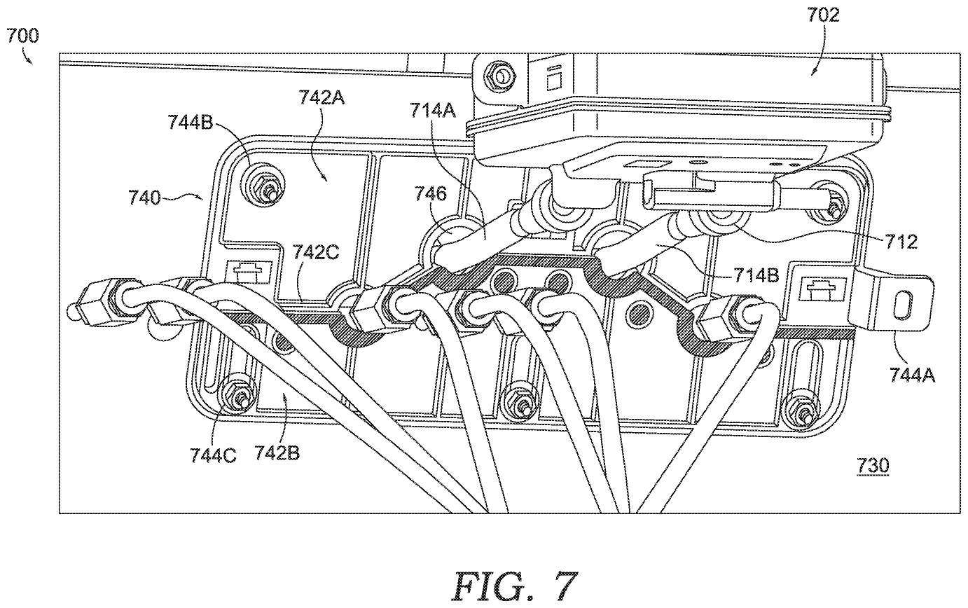

FIG. 7 depicts yet another view of an example brake fluid reservoir in example environment 700. Example environment 700 illustrates a brake fluid reservoir 702 that is in communication with the brake cylinder via brake fluid paths 714A and 714B, which each extend through an opening 746 of the seal 740 (e.g., plastic seal 640 of FIG. 6). As illustrated in example environment 700, the seal 740 has a top piece 742A and a bottom piece 742B (e.g., top piece 642A and bottom piece 642B of FIG. 6). In addition, seal 740 has mounting structures 744A, 744B, and 744C (e.g., mounting structures 644A, 644B, and 644C of FIG. 6).

In some embodiments, the brake fluid reservoir 702 can be located in a front compartment of the vehicle, and the seal 740 can be attached to a surface of the bulkhead 730 via mounting structures 744A, 744B, and 744C. The mounting structures 744A, 744B, and 744C can be fastened to the surface of the bulkhead 730, within the front compartment of the vehicle, via one or more fasteners, which may include one or more plastic or metal fasteners, for example. The one or more fasteners can include a screw (e.g., a machine screw, a sheet metal screw, a wood screw, a cap screw, or another type of screw), a stud, a washer, an anchor, a rivet, a nail, another type of fastener, or a combination thereof.

Additionally, the seal 740 can have at least one opening 746 for each of the brake fluid paths 714A and 714B to extend through the surface of the bulkhead 730 from the front compartment to another compartment associated with the brake cylinder. In example environment 700, other openings are formed through the seal 740 for other connections between the front compartment and the other compartment. As such, the top piece 742A of the seal 740 and the bottom piece 742B of the seal 740, together, form the border 742C between the top piece 742A and the bottom piece 742B. The border 742C includes the opening 746 in the seal 740 for the brake fluid path. Accordingly, top piece 742A of the seal 740 and the bottom piece 742B of the seal 740, together, form the portion of the seal 740 surrounding the brake fluid path 714A.

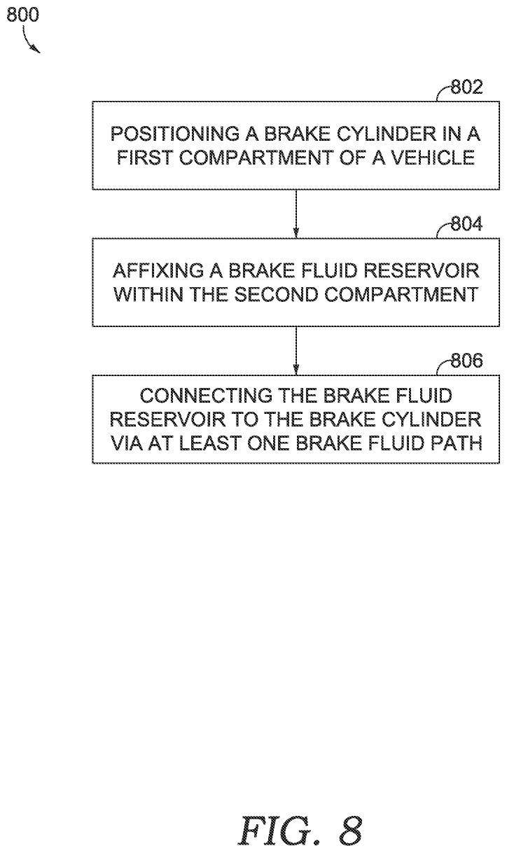

FIG. 8 depicts a flow diagram of an example method of for installing a remote brake fluid reservoir. At 802, a brake cylinder is positioned in a first compartment of a vehicle. For example, the first compartment may include a cabin room of the vehicle. The brake cylinder can be mounted to a bolster on a rail within the cabin of the vehicle, for example, by using studs or other mounting components. In some embodiments, the brake cylinder is positioned into the cabin via a locking mechanism. The first compartment corresponding to the cabin room is separated from a second compartment of the vehicle via a bulkhead. The bulkhead may be a front bulkhead, for example. In some embodiments, the bulkhead comprises sheet metal.

At 804, the brake fluid reservoir is affixed to the second compartment. The second compartment can be the front compartment of the vehicle. In some embodiments, the brake fluid reservoir is affixed to a mounting wall within the front compartment of the vehicle via the one or more mounting structures 204 of FIG. 2, the mounting structure 404 of FIG. 4, mounting structures 604A and 604 of FIG. 6, or another mounting structure. In some embodiments, the brake fluid reservoir is affixed at a center line of the vehicle. For example, the center line of the vehicle may be determined using at least two of the wheels of the vehicle.

At 806, the brake fluid reservoir is connected to the brake cylinder via at least one brake fluid path. The at least one brake fluid path can pass through an opening (e.g., opening 616A of FIG. 6) in the bulkhead, which separates the first compartment and the second compartment, from the second compartment to the first compartment of the vehicle. Furthermore, in some embodiments, a seal can be attached to the bulkhead. The seal can be placed over the opening in the bulkhead on a surface of the bulkhead facing inward to the second compartment. In some embodiments, the seal can be formed from plastic. The seal may comprise a plurality of openings that are smaller than the opening in the bulkhead, such that the brake fluid path can fit through the opening in the plastic seal. Stated differently, the at least one brake fluid path passes through the second compartment to the first compartment through one of the plurality of openings of the seal formed from the plastic.

Embodiment 1. A system, comprising: a bulkhead on a body of a vehicle, the bulkhead having a first side and a second side; a brake cylinder adjacent to the first side of the bulkhead; and a brake fluid reservoir adjacent to the second side of the bulkhead, the brake fluid reservoir coupled to the brake cylinder for the transfer of brake fluid to the brake cylinder.

Embodiment 2. The system of embodiment 1, wherein the brake fluid reservoir is located in a front compartment of the vehicle, and wherein the brake cylinder is located in a cabin of the vehicle.

Embodiment 3. The system of embodiments 1-2, wherein the brake fluid reservoir has a hermetic seal at a top portion of the brake fluid reservoir and a pair of bored cylinders molded into and extending from a bottom portion of the brake fluid reservoir and towards the second side of the bulkhead, the brake fluid reservoir being mounted to a mounting wall of the front compartment of the vehicle.

Embodiment 4. The system of embodiments 1-3, wherein the pair of bored cylinders are in communication with a pressure chamber of the brake cylinder via a quick connect end at each of the pair of bored cylinders and a corrugated hose clamped at the quick connect end.

Embodiment 5. The system of embodiments 1-4, wherein a center line of the brake fluid reservoir is aligned with a center line of the vehicle.

Embodiment 6. The system of embodiments 1-5, further comprising a plastic seal covering one or more openings between the first side and the second side of the bulkhead, the plastic seal coupled to a portion of the second side of the bulkhead, the plastic seal having at least one opening.

Embodiment 7. The system of embodiments 1-6, wherein a brake fluid path extends from the brake fluid reservoir to the brake cylinder through the at least one opening of the plastic seal.

Embodiment 8. The system of embodiments 1-7, wherein the body of the vehicle comprises a top portion joined to a bottom portion, wherein the top portion comprises one or more vehicle body panels, and the bottom portion comprises a vehicle chassis and the bulkhead.

Embodiment 9. A vehicle comprising: a bulkhead separating a first compartment and a second compartment; a brake cylinder located in the first compartment; and a brake fluid reservoir located in the second compartment, the brake fluid reservoir connected to the brake cylinder.

Embodiment 10. The vehicle of embodiment 9, wherein the first compartment is a cabin of the vehicle and the second compartment is a front compartment of the vehicle.

Embodiment 11. The vehicle of embodiments 9-10, further comprising a brake fluid path extending from the brake fluid reservoir located in the second compartment to the brake cylinder located in the first compartment through an opening in the bulkhead.

Embodiment 12. The vehicle of embodiments 9-11, further comprising a seal over the opening in the bulkhead, a portion of the seal surrounding the brake fluid path such that the brake fluid path extends from the second compartment to the first compartment through the bulkhead and the seal.

Embodiment 13. The vehicle of embodiments 9-12, wherein the seal is attached to a surface of the bulkhead facing inward to the second compartment.

Embodiment 14. The vehicle of embodiments 9-13, wherein the bulkhead is part of a bottom portion of a body of the vehicle, the body comprising a top portion joined to the bottom portion, and wherein the seal comprises at least two pieces that form the portion of the seal surrounding the brake fluid path.

Embodiment 15. The vehicle of embodiments 9-14, wherein a center line of the brake fluid reservoir is aligned with a center line of the vehicle.

Embodiment 16. A method for installing a remote brake fluid reservoir, the method comprising: positioning a brake cylinder in a first compartment of a vehicle, the first compartment separated from a second compartment of the vehicle via a bulkhead; affixing a brake fluid reservoir within the second compartment; and connecting the brake fluid reservoir to the brake cylinder via at least one brake fluid path.

Embodiment 17. The method of embodiment 16, wherein the at least one brake fluid path passes through an opening in the bulkhead from the second compartment to the first compartment of the vehicle.

Embodiment 18. The method of embodiments 16-17, further comprising attaching a seal over the opening in the bulkhead on a surface of the bulkhead facing inward to the second compartment.

Embodiment 19. The method of embodiments 16-18, further comprising forming the seal from plastic, the seal comprising a plurality of openings that are smaller than the opening in the bulkhead, wherein the at least one brake fluid path passes through the second compartment to the first compartment through one of the plurality of openings of the seal formed from the plastic.

Embodiment 20. The method of embodiments 16-19, wherein the brake fluid reservoir is affixed at a center line of the vehicle.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure. For example, the fluid lines or fittings described can be configured for use in various other components including, but not limited to, plumbing systems or other piping systems. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A system, comprising:
a bulkhead on a body of a vehicle, the bulkhead having a first side and a second side;
a brake cylinder adjacent to the first side of the bulkhead; and
a brake fluid reservoir adjacent to the second side of the bulkhead, the brake fluid reservoir coupled to the brake cylinder for the transfer of brake fluid to the brake cylinder.

2. The system of claim 1, wherein the brake fluid reservoir is located in a front compartment of the vehicle, and wherein the brake cylinder is located in a cabin of the vehicle.

3. The system of claim 2, wherein the brake fluid reservoir has a hermetic seal at a top portion of the brake fluid reservoir and a pair of bored cylinders molded into and extending from a bottom portion of the brake fluid reservoir and towards the second side of the bulkhead, the brake fluid reservoir being mounted to a mounting wall of the front compartment of the vehicle.

4. The system of claim 3, wherein the pair of bored cylinders are in communication with a pressure chamber of the brake cylinder via a quick connect end at each of the pair of bored cylinders and a corrugated hose clamped at the quick connect end.

5. The system of claim 4, wherein a center line of the brake fluid reservoir is aligned with a center line of the vehicle.

6. The system of claim 1, further comprising a plastic seal covering one or more openings between the first side and the second side of the bulkhead, the plastic seal coupled to a portion of the second side of the bulkhead, the plastic seal having at least one opening.

7. The system of claim 6, wherein a brake fluid path extends from the brake fluid reservoir to the brake cylinder through the at least one opening of the plastic seal.

8. The system of claim 1, wherein the body of the vehicle comprises a top portion joined to a bottom portion, wherein the top portion comprises one or more vehicle body panels, and the bottom portion comprises a vehicle chassis and the bulkhead.

9. A vehicle comprising:
a bulkhead separating a first compartment and a second compartment;
a brake cylinder located in the first compartment; and
a brake fluid reservoir located in the second compartment, the brake fluid reservoir connected to the brake cylinder.

10. The vehicle of claim 9, wherein the first compartment is a cabin of the vehicle and the second compartment is a front compartment of the vehicle.

11. The vehicle of claim 9, further comprising a brake fluid path extending from the brake fluid reservoir located in the second compartment to the brake cylinder located in the first compartment through an opening in the bulkhead.

12. The vehicle of claim 11, further comprising a seal over the opening in the bulkhead, a portion of the seal surrounding the brake fluid path such that the brake fluid path extends from the second compartment to the first compartment through the bulkhead and the seal.

13. The vehicle of claim 12, wherein the seal is attached to a surface of the bulkhead facing inward to the second compartment.

14. The vehicle of claim 12, wherein the bulkhead is part of a bottom portion of a body of the vehicle, the body comprising a top portion joined to the bottom portion, and wherein the seal comprises at least two pieces that form the portion of the seal surrounding the brake fluid path.

15. The vehicle of claim 9, wherein a center line of the brake fluid reservoir is aligned with a center line of the vehicle.

16. A method for installing a remote brake fluid reservoir, the method comprising:
positioning a brake cylinder in a first compartment of a vehicle, the first compartment separated from a second compartment of the vehicle via a bulkhead;
affixing a brake fluid reservoir within the second compartment; and
connecting the brake fluid reservoir to the brake cylinder via at least one brake fluid path.

17. The method of claim 16, wherein the at least one brake fluid path passes through an opening in the bulkhead from the second compartment to the first compartment of the vehicle.

18. The method of claim 17, further comprising attaching a seal over the opening in the bulkhead on a surface of the bulkhead facing inward to the second compartment.

19. The method of claim 18, further comprising forming the seal from plastic, the seal comprising a plurality of openings that are smaller than the opening in the bulkhead, wherein the at least one brake fluid path passes through the second compartment to the first compartment through one of the plurality of openings of the seal formed from the plastic.

20. The method of claim 16, wherein the brake fluid reservoir is affixed at a center line of the vehicle.
